(19) United States
(12) Patent Application Publication
(10) Pub. No.: US 2003/0195852 A1
(43) Pub. Date: Oct. 16, 2003

(54) System, method, apparatus and means for protecting digital content

(76) Inventors: Geoff Campbell, New York, NY (US); Peter Gutman, New York, NY (US); Martin Guillaume, New Rochelle, NY (US)

Correspondence Address: BUCKLEY, MASCHOFF, TALWALKAR, & ALLISON, 5 ELM STREET, NEW CANAAN, CT, 06840, US

(21) Appl. No.: 10/064,741

(22) Filed: Aug. 12, 2002

Related U.S. Application Data
(60) Provisional application No. 60/373,000, filed on Apr. 16, 2002.
(60) Provisional application No. 60/401,215, filed on Aug. 5, 2002.

(51) Int. Cl. G06F 17/60

(52) U.S. Cl. 705/51

(57) ABSTRACT

An item of content is protected by monitoring a plurality of file sharing networks to identify at least a first file sharing network having the item of content. At least first and second reference files associated with the item of content are created, where the first and second reference files each have a different format. A plurality of decoy files are created, including a first set of decoy files created from the first reference file, and a second set of decoy files created from the second reference file, where each of the decoy files including a defect. The decoy files are disseminated to the first file sharing network.

### CROSS REFERENCE TO RELATED APPLICATIONS

This application is based on and claims priority to U.S. Provisional Application Serial No. 60/373,000 filed Apr. 6, 2002 for “Copy Protection for Multimedia Content on the Internet” and Ser. No. ______ (Attorney Docket No. 109.001/P), filed on Aug. 5, 2002, the content of each of which is incorporated herein by reference for all purposes.

### BACKGROUND OF INVENTION

The present invention relates to network techniques. More particularly, embodiments of the present invention relate to network techniques for addressing the unauthorized distribution of digital content.

Advances in network and communications technologies have led to the widespread use and availability of information. Unfortunately, this has also led to the widespread copying and distribution of unauthorized copies of digital content. Digital copies of music, motion pictures, books, and other works of intellectual property are increasingly available over the Internet. This problem is exacerbated by the introduction and increasing popularity of peer-to-peer (“P2P”) networks which allow users to register to participate in a file sharing network and directly retrieve content stored at a computing device of another user.

Reference is now made to FIG. 1, where a network 10 is depicted which includes a file sharing network 108 over which user devices 102 interact to share files 40. File sharing network 108 may be any wired or wireless network which is configured to enable users operating user devices 102 to share files. For example, file sharing network 108 may be a peer to peer (“P2P”) network such as the existing networks organized by Gnutella, etc. Currently, users operating user devices 102 may utilize file sharing network 108 to make their files available for copying by other users. For example, the user operating user device 102a may register to participate in file sharing network 108 and may make files 40a and 40b available for distribution to other participants of file sharing network 108. Another participant of file sharing network 108, such as the user operating user device 102n, may interact with user device 102a over network 108 to make a copy of files 40a and 40b. In this manner, users may share and distribute files. Frequently, users share and distribute unauthorized copies of digital content.

The owners of digital content would like to reduce or control this unauthorized distribution of their works of intellectual property. A number of methods and techniques have been developed to combat this problem. For example, some types of digital content are protected using encryption or content protection schemes which attempt to prevent users from making and distributing unauthorized copies. Unfortunately, however, these content protection techniques are prone to hacking or circumvention. For example, content protection schemes do not prevent the “bootlegging” of motion pictures by audience members who illegally video tape the motion picture at a theatre. Some owners of digital content have attempted to prevent unauthorized distribution of their content by suing file sharing networks or individual users of file sharing networks. Unfortunately, this can be an expensive and inefficient process.

It would be desirable to provide a method and apparatus that can be employed to reduce the unauthorized dissemination of digital content over file sharing networks. It would further be desirable to provide a method and apparatus that overcame the drawbacks of the prior art.

### SUMMARY OF INVENTION

To alleviate the problems inherent in the prior art, and to provide improved abilities to protect content, embodiments of the present invention provide a system, method, apparatus and means for protecting digital content. In some embodiments, an item of content is protected by monitoring a plurality of file sharing networks to identify at least a first file sharing network having the item of content. At least first and second reference files associated with the item of content are created, where the first and second reference files each have a different format. A plurality of decoy files are created, including a first set of decoy files created from the first reference file, and a second set of decoy files created from the second reference file, where each of the decoy files includes a defect. The decoy files are disseminated to the first file sharing network.

In some embodiments, a number of dissemination agents are caused to register with the at least first file sharing network, and the disseminating includes causing the dissemination agents to disseminate the decoy files to the first file sharing network. In some embodiments, a number of query agents are caused to register with the file sharing network and the query agents are used to submit queries to the file sharing network.

In some embodiments, an analysis is performed to assess an effect of the disseminating on the file sharing network. In some embodiments, the analysis includes comparing information about the first file sharing network to an expected behavior model, and disseminating additional decoy files to the first file sharing network if the comparing indicates that the first file sharing network requires additional decoys. In some embodiments, network characteristics and/or decoy characteristics are altered based on the analysis.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF DRAWINGS

FIG. 1 is a block diagram of an existing file sharing network of the type in which features of embodiments of the present invention may be utilized.

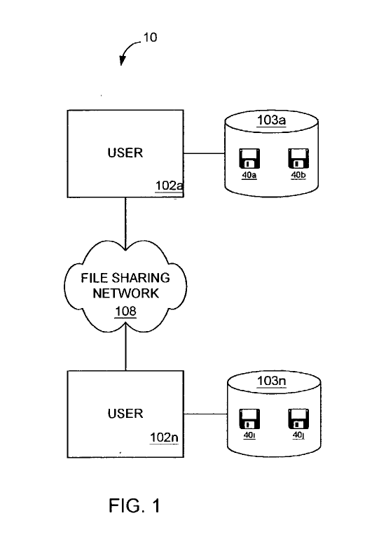

FIG. 2 is a block diagram of an exemplary protection system implementing features of embodiments of the present invention.

FIG. 3 is a block diagram of one embodiment of a content protection system device for use in embodiments of the present invention.

FIG. 4 is a flow diagram illustrating an exemplary process for protecting content according to some embodiments of the present invention.

FIG. 5 is a flow diagram illustrating an exemplary process for registering an agent according to some embodiments of the present invention.

FIG. 6 is a flow diagram illustrating an exemplary process for creating a query according to some embodiments of the present invention.

FIG. 7 is a flow diagram illustrating an exemplary process for creating a decoy according to some embodiments of the present invention.

FIG. 8 is a flow diagram illustrating an exemplary dissemination process according to some embodiments of the present invention.

FIG. 9 is a flow diagram illustrating an exemplary monitoring process according to some embodiments of the present invention.

FIG. 10 is a flow diagram illustrating an exemplary analysis process according to some embodiments of the present invention.

FIG. 11 is a flow diagram illustrating an exemplary network adjustment process according to some embodiments of the present invention.

FIG. 12 is a flow diagram illustrating an exemplary decoy adjustment process according to some embodiments of the present invention.

### DETAILED DESCRIPTION

Applicants have recognized that there is a need for systems, methods, apparatus, and means for protecting digital content. According to some embodiments, digital content is protected under the control of a content protection system which operates to analyze one or more file sharing networks, create a number of decoy files based on the analysis, disseminate the decoy files to file sharing networks, and monitor and analyze the results of the dissemination. According to some embodiments, the monitoring and analysis may result in further disseminations in order to achieve a desired efficacy.

A number of terms are used herein to describe features of embodiments of the present invention. As used herein, the term “content” is used to refer to digital data which is configured to include some work of authorship or other intellectual property such as, for example, a video, a piece of music such as a song, a motion picture and/or motion picture soundtrack, software, executable code, an image, or the like. As used herein, the term “protected content” or “content to be protected” is used to refer to a particular item of content for which features of embodiments of the present invention are used to reduce, eliminate, or otherwise impair unauthorized distribution and use. For example, a record label may utilize features of embodiments of the present invention to reduce, eliminate, or otherwise impair unauthorized distribution of a hit single.

As used herein, the term “file” is used to refer to an entity of digital data available on a file sharing network. An item of content to be protected may be embodied in a single file, or it may be distributed in several files. In general, a “file” includes data (such as meta-tags or other meta-data) which is contained in a header of the file and which defines attributes of the contents of the file. A “file” also includes the content. The content may be in the clear or it may be encrypted or otherwise encoded. Typically, as used herein, a “file” is identified by a filename. Each file has a size. Each file also has a format type. For example, a file containing a video may be formatted as an MPEG file (with a .mpg file extension) or in any other file format allowing the play of video images. A file containing an audio recording may be formatted as an MPEG-3 file (with an .mp3 file extension), or in any other file format allowing the play of sound recordings. A file may also be compressed (e.g., using any available file compression program such as PKZIP® or the like) or otherwise encoded.

As used herein, the term “file sharing network” is used to refer to a network over which users may make files available to each other for download. As used herein, a file sharing network includes recombinant, ad hoc networks that allow users to establish links with peers. An example of a file sharing network is a peer to peer (“P2P”) network such as the networks organized by Gnutella, Fasttrack, Morpheus, Napster, etc. As used herein, a file sharing network may be a specially constructed network in which users may share files with each other, or it may be a transient Internet network that allows a group of computer users with the same networking program to connect with each other and directly access files from one another's hard drives. File sharing networks include wired and wireless networks.

Prior to providing a detailed description of embodiments of the present invention, an introductory example will now be described to facilitate understanding of various features of embodiments of the present invention. In this example, a college student is operating a personal computer to download items of content. The college student is registered to participate in a number of file sharing networks such as Gnutelia (that is, the college student is a “user” in a file sharing network). For example, the college student may be operating software on his computer which allows him to interact with the Gnutella file sharing network. By participating in the network, the student is able to download files made available by other users in the network.

In this example, the college student wishes to download an unauthorized copy of the motion picture “SHREK” which is owned by Dreamworks SKG, LLC (in this example, Dreamworks SKG is the “content provider” and SHREK is the “content to be protected”).

To do so, the student must first locate a copy of the film somewhere in one of the file sharing networks in which he is registered to participate. The student may locate a copy by submitting one or more queries to the file sharing networks in an attempt to locate a copy (e.g., by submitting queries seeking files labeled as containing content related to “SHREK”. A number of different files may match the search criteria and the student may pick one or more to download onto his computer. Because the file may be very large (e.g., greater than 10-20 megabytes in size), the download may take a substantial amount of time to complete. Once the file has successfully downloaded, the student may run an application (e.g., such as Windows Media Player® or the like) to view the video.

Pursuant to some embodiments of the present invention, the file downloaded by the student may be a “decoy” file which has been created using embodiments of the present invention. The decoy file is created with one or more defects which effectively render the file unusable or otherwise undesirable. For example, when the student views the video, he may find that the video and/or its soundtrack have been modified such that viewing the video is difficult. In many circumstances, the student will be motivated to purchase a legitimate, licensed copy of the video rather than wasting time downloading potentially defective files. Some embodiments of the present invention allow the dissemination, creation, and modification of these decoy files in a manner which allows the efficacy of the dissemination to be monitored and adjusted, thereby allowing the decoy distribution to be optimized and the unauthorized distribution minimized.

For example, a service provider or other company operating a system (referred to herein as a “content protection system”) configured pursuant to some embodiments of the present invention may perform an initial monitoring or querying of file sharing networks to identify unauthorized distribution of SHREK. This initial monitoring or querying of file sharing networks may be performed at the request of, or otherwise on behalf of Dreamworks. These queries may be conducted using one or more query agents which register with one or more file sharing networks. The initial queries may be used to identify the file sharing networks which are distributing unauthorized content and may also be used to identify the format and other attributes of the unauthorized content.

For example, the service provider may identify that one particular file sharing network is the greatest distributor of unauthorized copies of SHREK. The service provider may also identify that most of the unauthorized copies are disseminated in two formats—MPG and WMF. Based on this information, the service provider may create two “reference files” in each of these formats. The two reference files are then used to create a number of decoy files, each decoy having one or more defects (e.g., a number of decoy files may be made from the MPG format reference file and a number of decoy files may be made from the WMF format reference file). These decoy files are then disseminated through the file sharing network using one or more agents who have registered to participate in the file sharing network as participants.

Embodiments of the present invention allow the service provider to continue to monitor the file sharing network to determine if the dissemination achieved a desired effect. If, for example, the dissemination was intended to ensure that at least 40% of the “SHREK” files on the network are decoy files, the network may be monitored to identify if this target has been reached. If the target has not been reached, a further dissemination of decoys may occur. In some situations, one or more characteristics of the decoys may be modified to improve their efficacy (e.g., by changing the file name, changing the defects, etc). In some situations, one or more characteristics of the dissemination may be modified to improve its efficacy (e.g., by changing the number of agents, registering different agents, changing the time of dissemination, etc.). Further monitoring may then be performed to again determine the efficacy of the dissemination. This process may continue until a desired efficacy is reached. In some embodiments, a model is developed and modified based on information learned from each dissemination. This example has been presented for the purposes of illustrating various aspects of some features of some embodiments of the present invention. Other features will become apparent upon reading the following disclosure. To further assist in the illustration of features of some embodiments of the present invention, the above example will be continued throughout the remainder of the disclosure.

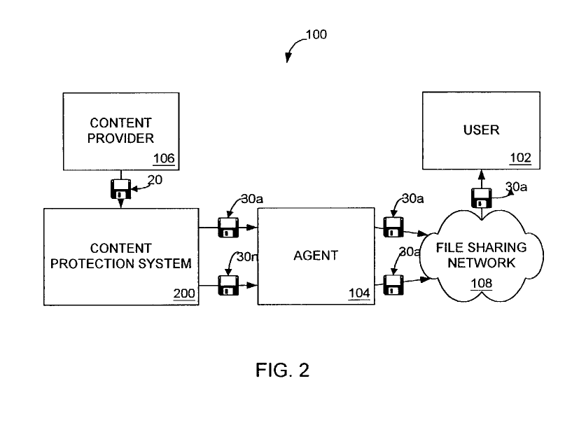

SYSTEMReference is now made to FIG. 2, where a protection system 100 is depicted pursuant to some embodiments of the present invention. As depicted, protection system 100 includes a content provider 106 in communication with a content protection system 200. Content protection system 200 is in communication with an agent 104 which is registered (or is directed to become registered) to participate in a file sharing network 108 to share files with other users of file sharing network 108, such as a user operating user device 102.

Content provider 106 may be an entity which produces, distributes, or otherwise owns content. For example, content provider 106 may be a movie studio, a recording studio, a recording artist, an agent or agency, or the like. Content provider 106 may own or otherwise have the right to control distribution and/or copying of content such as content embodied in file 20. Content provider 106 may retain or otherwise interact with content protection system 200 in order to utilize services of content protection system 200 to protect or reduce unauthorized copying of content such as the content embodied in file 20. In some embodiments, content provider 106 may transmit a digital master copy of an item of content to be protected to content protection system 200. In some embodiments, content provider 106 may transmit details identifying characteristics of an item of content to be protected to content protection system 200.

Although only a single file 20 representing content to be protected is depicted, each content provider 106 may request that a number of items of content be protected by content protection system 200. In some embodiments, content provider 106 and content protection system 200 may be in communication via a network (such as the Internet) or via a direct connection such as a wired or wireless connection.

Further, as used herein, any or all of the devices may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

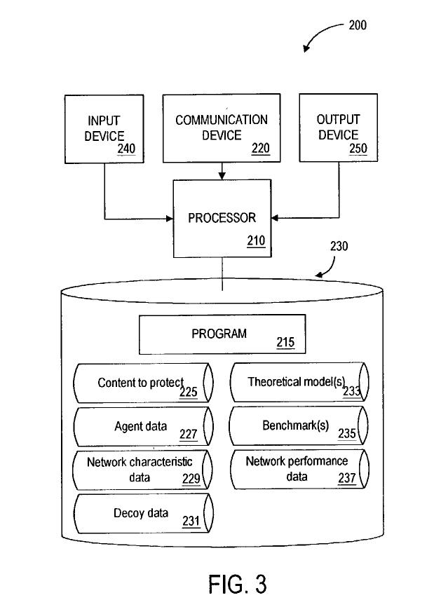

Content protection system 200 may be formed from one or more devices configured to operate pursuant to embodiments of the present invention. In some embodiments, content protection system 200 is operated by (or on behalf of) a service provider which provides content protection services to one or more content providers. In some embodiments, content protection system 200 may be operated by (or on behalf of) a content provider. Further details of one embodiment of content protection system 200 will be described below in conjunction with FIG. 3.

Still referring to FIG. 2, content protection system 200 communicates one or more decoy files 30 to one or more agents 104 for distribution to users 102 via one or more file sharing networks 108. Agent 104 may be a real person operating a computing device to interact with a file sharing network or agent 104 may be a virtual agent (e.g., a computing device configured to operate as a user of a file sharing network). Pursuant to some embodiments, an agent may be a query agent and/or a dissemination agent. For example, a query agent may be an agent 104 which is configured to interact with one or more file sharing network 108 to submit queries at the request of content protection system 200 (e.g., queries may be designed to identify unauthorized content on the networks). Query agents may be utilized prior to dissemination to identify unauthorized content. Query agents may be utilized after a dissemination to assist in the monitoring and analysis of the efficacy of the dissemination.

An agent 104 may act as a dissemination agent under the direction of content protection system 200. For example, content protection system 200 may cause a number of agents 104 to disseminate decoy files 30 to file sharing networks 108. The dissemination may include providing each agent with one or more dissemination instructions (e.g., such as the time of dissemination, etc.). An agent may disseminate file 30 by making the file available for sharing by other users 102 of a file sharing network 108.

For the purposes of introducing features of embodiments of the present invention, only a single content provider 106, content protection system 200, agent 104, file sharing network 108 and user device 102 are shown. However, in some embodiments, a number of such devices may be provided. For example, in some embodiments, content protection system 200 is in communication with a number of different content providers 106 and with a number of different agents 104 to distribute decoy files to a number of different user devices 102 via a number of different file sharing networks 108. In some embodiments, a number of different content protection systems 200 are operated to interact with a number of different content providers 106 and agents 104 to distribute decoy files to a number of different user devices 102 and file sharing networks 108. Upon reading this disclosure, those skilled in the art will appreciate that a number of different configurations may be utilized to effectively disseminate decoy files across networks.

DEVICESAny of a number of different types of devices may be used to provide features of embodiments of the present invention. For example, content provider 106, content protection system 200, agent 104 and user 102 may be implemented using computing devices, such as, for example, those based on the Intel® Pentium® processor. The computing devices may be configured in any of a number of different manners, such as, for example, as a desk-top computer, lap-top computer, handheld computer, personal digital assistant (PDA), or the like. Each user device 102 may operate software applications allowing the device to communicate and participate in one or more file sharing networks 108. Similarly, each agent 104 may also operate software applications allowing the agent to communicate and participate in one or more file sharing networks 108 as needed to perform its function as a query and/or dissemination agent. Further, each agent 104 is configured to communicate with content protection system 200 (e.g., to receive query and/or dissemination instructions and to provide query results and other information to content protection system 200).

Content protection system 200 may be configured in any of a number of ways known to those skilled in the art, such as, for example, an Intel® Pentium® based-computer or the like. Content protection system 200 may function as a “Web server” that generates Web pages (documents on the Web that typically include an HTML file and associated graphics and script files) that may be accessed via the Web and allows communication with other devices in a manner known in the art. For example, content protection system 200 may be configured to receive requests from content providers 106 such as requests to perform content protection services on behalf of a content provider. In some embodiments, Web pages may be provided which allow a content provider to provide instructions defining a particular request for content protection services, including information defining a particular item of content to be protected. In some embodiments, a content provider may also provide information defining particular file sharing networks to be targeted and/or information defining the nature of the dissemination including any desired benchmarks to be attained.

FIG. 3 illustrates an embodiment of a content protection system 200. As depicted, content protection system 200 includes a computer processor 210 operatively to a communication device 220, a storage device 230, an input device 240 and an output device 250. Communication device 220 may be used to facilitate communication with, for example, other devices (such as content providers 106 and agents 104). Input device 240 may comprise, for example, a keyboard, a keypad, a mouse or other pointing device, a microphone, knob or a switch, an infra-red (IR) port, a docking station, and/or a touch screen. Input device 240 may be used, for example, to enter information (e.g., information regarding content to be protected, benchmarks, file sharing networks, models, or the like). Output device 250 may comprise, for example, a display (e.g., a display screen), a speaker, and/or a printer.

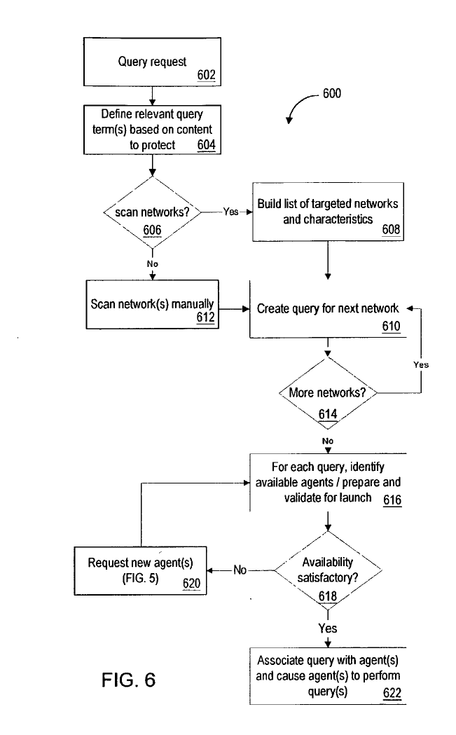

Storage device 230 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. In the embodiment depicted, storage device 230 stores one or more programs 215 for controlling processor 210. Processor 210 performs instructions of program 215, and thereby operates in accordance with the present invention. In some embodiments, program 215 includes a number of subroutines or processes which perform different functions. For example, program 215 may include processes such as: agent registration; decoy creation; decoy dissemination; network monitoring; network analysis; network adjustment; and decoy adjustment. Details of some embodiments of these processes will be described further below in conjunction with FIGS. 6-12.

Storage device 230 also stores databases and other information stores, including, for example, information defining: content to protect 225, agent data 227, network characteristic data 229, decoy data 231, theoretical model(s) 233, benchmark(s) 235 and network performance data 237. Storage device 230 may be a distributed device (e.g., some or all of the data may be located remote from content protection device 200).

Content to protect 225 may include data defining one or more items of content to be protected (e.g., including information received from one or more content providers). For example, if the item of content is the SHREK motion picture, content to protect 225 may include a copy of the motion picture and/or data defining the size and other characteristics of the motion picture. In some embodiments, data may also be stored at 225 which identifies one or more reference files that are created based on the content to protect. The creation of these reference files will be described further below.

Agent data 227 may include data defining one or more agents 104 which have been created on behalf of content protection system. Data may include an address of each agent, information identifying which file sharing network(s) the agent is registered to participate in, etc. If an agent is a real person, data may also be provided identifying the person and also identifying whether (and on what terms) the individual is being compensated to act as an agent. Other data may also be provided, including, for example, information identifying a query and/or dissemination history of the agent, etc.

Network characteristic data 229 may include data defining one or more characteristics of file sharing network(s) 108. For example, data may be provided defining a variety of characteristics of each file sharing network 108 with which content protection system 200 monitors or otherwise interacts. Network characteristic data may include: the maximum number of peers allowed on the network; any limits on the amount of network throughput (or bandwidth) allowed for specific tasks (such as downloading); information identifying the particular network syntax which is used to register to participate in the network; connectivity requirements; or the like. This information may be updated on a regular or on an as-needed basis to ensure that the vagaries of each different file sharing network 108 are known.

Decoy data 231 may include data defining one or more decoys which have been created by content protection system 200. A number of different types of decoys may be created for each item of content to be protected. Decoy data 231 may specifically identify each of these different decoys. For example, in the hypothetical presented above where SHREK is the item of content to be protected, and where two different file formats of unauthorized content have been identified on a file sharing network, two sets of decoy files may be created (one in MPG format, one in .WMF format). Further, each .MPG format decoy may include one or more different types of defects. Information at 231 may identify these different configurations of decoy files so that the relative efficacy of each may be monitored. For example, if a particular decoy is created in MPG format and includes a defect where the soundtrack has been modified, information identifying the particular configuration is stored at 231. In some embodiments, each decoy may further include a watermark or other identifying characteristic which allows content protection system 200 to particularly identify the decoy as one having been created under its control. For example, the text or meta-descriptor associated with each decoy may be generated to allow content protection system 200 to identify the file as a decoy (e.g., by using a particular coding or naming scheme). As another example, information may be embedded in the content of the decoy (e.g., in an early portion of the content) which associates the content with information in a meta-descriptor associated with the decoy, allowing content protection system 200 to identify that the content associated with the decoy has not been modified or replaced. As yet another example, a watermark, digital signature, hash, or other identifier may be incorporated in the decoy to allow content protection system 200 to uniquely identify the decoy as one having been created under its control or using its techniques. In this manner, content protection system 200 may readily and accurately identify each decoy created by content protection system 200, allowing decoy files to be distinguished from unauthorized content (or, in some embodiments, from other decoys). In some embodiments, the use of such identifying information may be used by content protection system 200 to search for and remove decoys.

Theoretical model(s) 233 may include data defining one or more theoretical models which have been created for use in monitoring and analyzing the efficacy of decoys disseminated under control of content protection system 200. A number of different theoretical models may be stored at 233. For example, a unique model may be created for each item of content to be protected. As another example, different models may be used for different types of content (e.g., one model may be used for video content while another model may be used for audio content). In some embodiments, models may be network-specific and are a representation of expected behaviors exhibited by the network under specific circumstances. Pursuant to some embodiments, theoretical model(s) 233 are updated as content protection system 200 continues to monitor and analyze network data. A number of different variables may be monitored and utilized to implement a theoretical model.

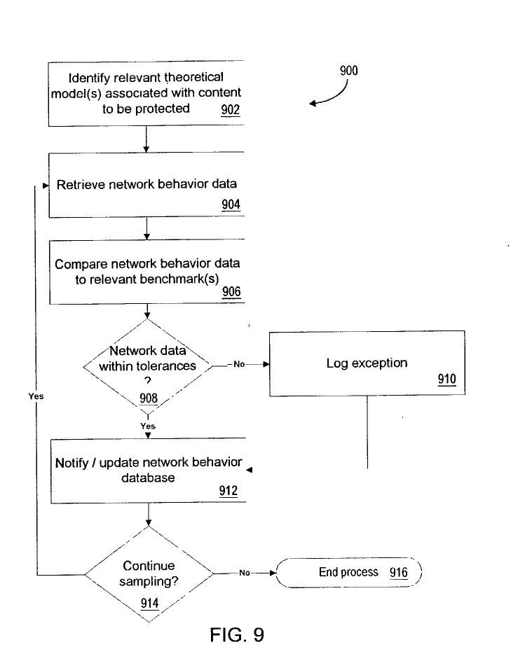

For example, the following network characteristics may be monitored (via one or more query agents acting under the direction of content protection system 200): a number of agents online by network (handle); an age of agents (handle); a number of files shared by agents; a mix of files being shared (e.g., nature, format); an agent schedule of connection to the networks; the bandwidth made available to peers; the number of peer connections allowed; an age of IP address; a time & frequency of peer connection(s); a number of download attempts, success, aborts, cancellations, resumes; the “TTL” (time to live); an address of peers; the user identification of peers (handle); the name of directories & file name used; a frequency of decoy content changes; specific network characteristics (e.g., the “SuperNode” status of the Kazaa file sharing network); a variability of bandwidth over time; firewall usage; inter user messaging activity; or the like. This information may be retrieved by one or more monitoring processes (e.g., as described below in conjunction with FIG. 9).

Benchmark(s) 235 may include data identifying one or more benchmarks which are established to assist in monitoring and analyzing the efficacy of the dissemination of decoys under control of content protection system 200. For example, a benchmark for a particular dissemination may be established by a content provider. As a particular example, using the hypothetical introduced above, Dreamworks may request that the entity operating content protection system 200 achieve a target of 40% penetration of a particular file sharing network (i.e., 40% of files purporting to contain the film SHREK on network 108 are decoy files generated by system 200). This performance benchmark may then be used as a measure to determine when the dissemination has achieved its desired result. If monitoring indicates that the target has not yet been reached, system 200 may operate to modify one or more characteristics of the decoys and/or of the dissemination and disseminate further decoys. This process may be repeated until a desired efficacy is reached and/or to maintain a desired efficacy.

As will be described below, embodiments of the present invention allow the monitoring and analysis of networks to determine if the dissemination requires adjustment or modification. Other types of benchmarks may also be established to allow the monitoring and analysis of the efficacy of disseminations.

Network performance data 237 may include data identifying one or more network performance characteristics. The data may include separate data for each item of content being protected. The data may include separate data for each file sharing network which is monitored. Network performance data 237 may be collected from file sharing networks 108 by causing agents 104 to perform particular network queries. For example, if network data is desired to identify the number of unauthorized copies of SHREK on a network, one or more agents 104 may be instructed to perform one or more queries attempting to identify files available through network 108 which purport to include the film SHREK. Network performance data 237 may be retrieved on a regular basis to identify changes in network performance. For example, a first distribution of SHREK decoy files may be made at 7:00 PM EST on Tuesday Jul. 23, 2002. Network queries may be performed on a regular basis thereafter to identify how the distribution affects the overall network 108. For example, network queries may be performed every 24 hours to identify how the SHREK decoys are being distributed.

For example, network performance data may be retrieved to identify whether the SHREK decoys are being made available by other users of the network. Network performance data may also be retrieved to determine whether one of the decoys is working better than the other decoys. The retrieved network performance data may then be used to determine the efficacy of the dissemination (e.g., by running the network performance data through one or more theoretical models and/or comparing the network performance data to one or more benchmarks). The retrieved network performance data may also be used to identify certain decoy and dissemination characteristics which are particularly effective (or those which are particularly ineffective). For example, monitoring the effects of dissemination of SHREK decoys at 7:00 PM EST may reveal that 7:00 PM EST dissemination is particularly effective. This information may be used to update theoretical model(s) stored at 233.

Those skilled in the art will recognize, upon reading this disclosure, that other types and combinations of data may also be stored at (or accessible to) data protection system 200.

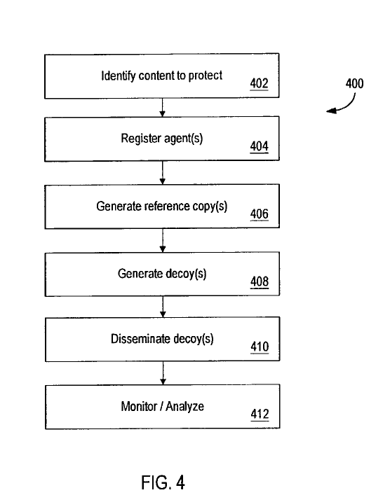

PROCESS OVERVIEWReferring now to FIG. 4, a process 400 is depicted for protecting content according to one embodiment of the present invention. Some or all of the steps of the process 400 may be performed by a single system such as content protection system 200 of FIG. 2. In some embodiments some or all of the steps of the process 400 may be performed by several devices operated by one or more entities operating together or in a cooperative fashion to perform features of embodiments of the present invention. The particular arrangement of elements in the flow chart of FIG. 4 (as well as the other flow charts described herein) is not meant to imply a fixed order to the steps. Embodiments of the present invention can be practiced in any order that is practicable. One exemplary embodiment will now be described by reference to FIG. 4 in which the steps of process 400 are performed by, or under control of, content protection system 200.

Process 400 begins at 402 where content to protect is identified. For example, processing at 402 may include the receipt of a request from a content owner to utilize features of embodiments of present invention in order to protect an item of content. In the example introduced above, processing at 402 may include receiving a request from Dreamworks to perform activities to impair unauthorized copying of SHREK. Processing at 402 may include receipt of a copy of the content to protect. For example, in one embodiment, processing at 402 includes receipt of a digital master copy of the content to protect. For example, if the content to protect is a movie and its accompanying sound track processing at 402 may include receipt of a certified copy or digital master of the movie and its sound track from the content owner. This content to be protected may be received for example, over the Internet or via other forms of communication from the owner of the content. In some embodiments, processing at 402 may simply include receiving information identifying the content to protect (e.g., a title and other characteristics of the content).

Identification of the content to protect may also include identifying particular attributes of the content. For example, processing at 402 may include identifying a size of the content, identifying particular display characteristics of the content, or the like. Once content to be protected has been identified, processing continues at 404 where one or more agent(s) are registered. In some embodiments this registration of agent(s) may occur before a particular piece of content to be protected is identified. Processing at 404, in some embodiments, includes identifying a number of physical or virtual agent(s) associated with one or more file sharing networks in which it is suspected that knock-off or unauthorized copies of the content to be protected have been distributed.

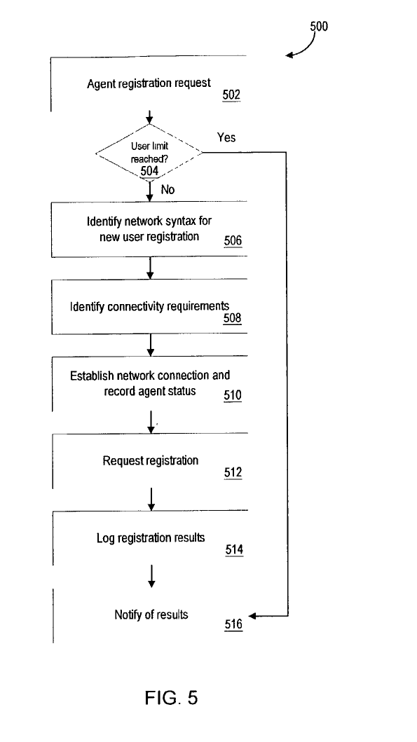

Registration of agent(s) will be described in further details below in conjunction with FIG. 5. In general, registration of agent(s) at 404 includes causing physical or virtual agent(s) to join or register to participate in those file sharing networks on which unauthorized content is being shared. In some embodiments, processing at 404 includes determining the particular requirements of each filing sharing network, and then registering agent(s) on that network. Once a sufficient number of agent(s) have been registered at 404, processing continues at 406 where one or more reference copies of the content to be protected are generated. This generation of reference copies may include performing a number of queries through the agent(s) of each of the file sharing networks on which unauthorized content has been distributed. For example, the queries may be performed to identify different unauthorized copies of the content which have been distributed over the file sharing networks. For example, one file sharing network may have distributed unauthorized copies of the movie in a particular format and size (e.g., in the example, the network may have users distributing a *.MPG and a *.WMF version of the SHREK movie).

Queries generated at 406 may be designed to identify this unauthorized content and its attributes. It is contemplated that the processing at 406 may include the identification of a number of different types of formats of unauthorized content which is spread across the multiple file sharing networks. Processing at 406 includes identifying the characteristics of each of these unauthorized copies and using the information to generate one or more reference copy(s). In particular, one reference copy may be created for each format of unauthorized content. In the SHREK example, a reference copy may be created in MPG format and in WMF format. That is, in some embodiments, if a number of knock-off copies of a movie are found distributed over several file sharing networks, and if each of the unauthorized copies has a different format, this information will be used to generate individual reference copy(s) which mimic the characteristics of the unauthorized content. Once one or more reference copies are generated at 406, information identifying the reference copies may be stored at content protection system 200.

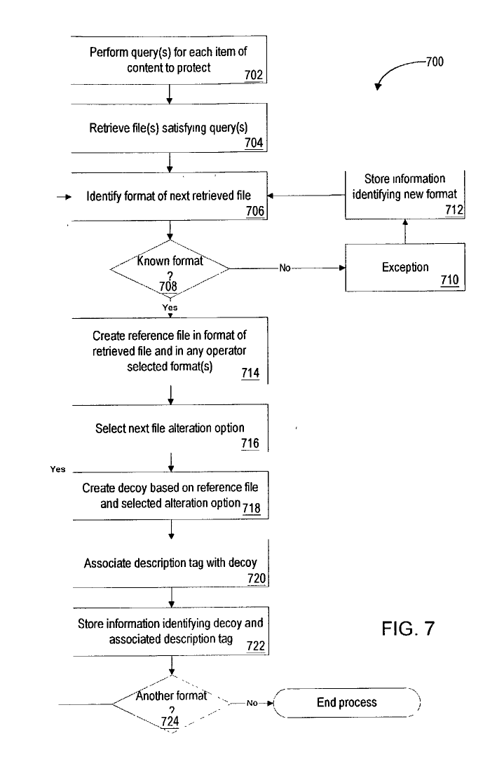

Further details of the generation and performance of queries will be described further below in conjunction with FIG. 6. Further details of the creation of reference files will be described below in conjunction with FIG. 7. Processing continues at 408 or one or more decoy(s) are generated. In some embodiments, a number of different decoy(s) are generated for each reference copy created at 406. For example, if unauthorized copies of a movie are found in two different file formats, two different reference copy(s) will be created at 406 and multiple copies of decoys may be generated at 408.

Pursuant to some embodiments, different groups or sets of decoys may be based on a different reference copy and based on a different defect inserted into the reference copy. A number of different defects may be inserted into the decoys. For example, one set of decoys may be created in .MPG format and having a first type of defect (e.g., the soundtrack may be replaced with a soundtrack of a different movie). A second set of decoys may be created in .MPG format and having a second type of defect (e.g., the sound may be impaired). Yet other sets may be created in .WMF format with other defects.

For example, if the content to be protected is a movie, the movie images may be replaced with repeating, degrading images. Further, the sound track may be replaced with a different language sound track or the sound quality may be degraded. Other defects will be described further below. In some embodiments, the generation of decoy(s) at 408 includes generating decoy(s) which have defects later in the performance of the content. For example, if the content to be protected is a movie, the defects may be inserted after the first 20 minutes or so of playtime. This is intended to discourage users from viewing the illicit content, as they become frustrated when the movie that they are watching degrades after 20 minutes of viewing. The generation of decoy(s) at 408 includes, in some embodiments, recording each of the different characteristics of each of the different decoy files created and storing that information at, for example, content protection system 200 (e.g., as decoy data 231). Once a number of decoy(s) have been generated, processing continues to 410.

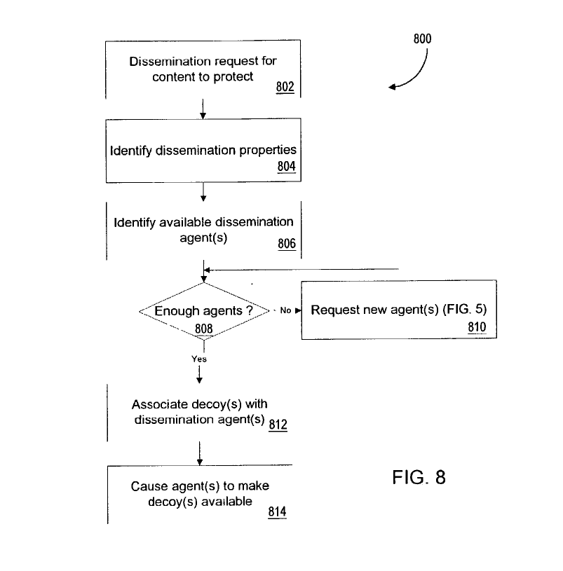

Processing at 410 includes the dissemination of decoy(s). Pursuant to some embodiments of the present invention, each of the decoy(s) generated at 408 are distributed or disseminated to targeted file sharing networks through the agent(s) that have been registered at 404. Processing at 410 may include communicating a number of dissemination instructions to one or more agent(s). These dissemination instructions may be used as a script by each of the agent(s) describing when and how the dissemination should occur. For example, the dissemination instructions may include a time of dissemination, the number of copies that should be made available, or the like. Further description of the dissemination process will be provided below in conjunction with FIG. 8.

Pursuant to some embodiments of the present invention, content protection system 200 operates to continuously adapt to the network environment. In some embodiments, the system adapts to network changes through a process of monitoring and analysis which occurs at 412. For example, pursuant to some embodiments a number of spot checks of the networks may be performed under the control of content protection system 200. The spot checks may be performed via one or more of the agent(s) registered at 404. The spot checks may be used to retrieve network behavior data or data about each of the file sharing networks at issue. The network behavior data received may be compared to the benchmarks to determine if the number and type of decoy(s) which were disseminated are performing their objective.

In some embodiments, one or more theoretical models may be used to generate benchmarks and to analyze the efficacy of the decoy(s). In some embodiments, if a comparison between the network behavior data and the benchmarks shows that the decoy(s) are not doing their intended job, one or more adjustments may be performed. For example, in some embodiments a network adjustment may be performed to modify characteristics of, for example, the agents registered or the like.

In some embodiments, one or more decoy adjustments may be performed to adjust one or more characteristics of the decoy(s) which have been disseminated. For example, analysis may indicate that the number of decoys disseminated is insufficient to achieve a desired reduction in the number of unauthorized files which are shared on a particular network.

Processing at 412 may indicate that a greater number of decoys should be disseminated to that particular network. As another example, an analysis may indicate that networks which received decoy at a particular time of day shows better results. This analysis may be propagated to other networks by adjusting the time of day in which decoys are disseminated to those networks. Other adjustments may also be performed to improve the efficacy of the protection system 200 of the present invention. Further details of monitoring and analysis pursuant to embodiments of the present invention will be described further below in conjunction with FIGS. 9 through 12.

AGENT REGISTRATIONReference is now made to FIG. 5, where an agent registration process 500 is depicted. Agent registration process 500 may be performed a number of different times under the direction of content protection system 200. For example, when content protection system 200 receives a request from a content provider 106, a number of agents may be registered in order to perform one or more queries of file sharing networks 108 to identify unauthorized content. As another example, agents may be registered during the monitoring or analysis of the efficacy of a dissemination.

Agent registration process 500 begins at 502 where an agent registration request is received. In some embodiments, this agent registration request may be both generated and received by content protection system 200 (e.g., one process of content protection system 200 may request the registration while another process of content protection system 200 may receive the registration request). For example, an agent registration request may be received by content protection system 200 prior to the submission of queries to a number of file sharing networks. Agent registration requests may also be received from during analysis of efficacy, prior to dissemination, prior to submission of queries, and in conjunction with adjusting network or decoy characteristics. In some embodiments, the agent registration request may include details defining the nature of the registration request (e.g., the request may specify that 10 agents are to be registered to participate in the Gnutella file sharing network).

Based on the registration request, an appropriate network syntax and protocol is identified. Using the appropriate protocol for the network being targeted, the agent registration process causes the registration of one or more agents (actual or simulated users) who will act as agents of content protection system 200 to determine submit queries, disseminate decoys and otherwise act to assist in identifying the nature, frequency of occurrence and quality of digital content on one or more file sharing networks.

New agents are created for the purpose of establishing gateways into the targeted networks. These users may be remotely controlled from content protection system 200 and may be registered from various distributed locations. Alternatively, existing network users can be enrolled for the purpose of querying the networks and relaying the results back to content protection system 200. The use of such users may require that content protection system 200 trust them to return accurate query results. In some embodiments, registered users will be paid for their participation (in both query and dissemination processes). Whether simulated or real, the users registered in the process of FIG. 5 may be referred to herein as either “query agents” or “dissemination agents”, depending on the task for which they are registered and utilized. Preferably, these agents are registered and configured in a manner such that they are generally indistinguishable from other users. For example, agents may be configured in a fashion which is representative of the average user profile on the network in which they are registered.

A determination is made at 504 if a user limit of the particular network has been reached. In some embodiments, each file sharing network 108 may have a limit on the number of agents that the file sharing network supports. For example, a public network such as Kaaza may have a limit of 20,000 users which may participate in the network, while a private intranet may allow a maximum of only 100 agents. A test is performed at 504 to determine if the user limit has been reached for the particular file sharing network. If the user limit has been reached, processing continues at 516 where the result is recorded and an operator is notified. If the user limit has not been reached, processing continues at 506 where network syntax for new user registration of the particular network(s) are identified. This information may be retrieved, for example, from network characteristic data 229 of content protection system.

In some embodiments, network characteristic data 229 is periodically updated to reflect current network rules and to include information about new networks. In registering a new agent, connectivity parameters associated with a particular network may also be identified at 508. Connectivity parameters are, for example, the configuration settings related to a particular file sharing network, for example, the number of simultaneous downloads allowed or maximum bandwidth allowed per peer. This information may also be stored or associated with network characteristic data 229 at content protection system 200.

Processing continues at 510 where a network connection is established by the agent and the status of the agent is recorded at, for example, agent data 227 of content protection system 200 (e.g., information may be stored indicating that a particular agent is connected to a particular network). Agent data 227 may thus effectively serve as a directory of available and busy agents and their connection information.

Processing continues at 512 where a request is made to register the agent. This request is submitted to the file sharing network 108 pursuant to the normal registration requirements of that file sharing network. Processing continues at 514 where the results of the registration are stored. For example, this information may be stored with agent data 227 and may include information such as the agent identifier, the network name on which the agent is registered, a user name utilized by the agent when registering, a time of registration, and information acknowledging successful network registration. Processing continues at 516 where a confirmation of completion is provided (e.g., this confirmation may be submitted to the process which requested the registration in the first place).

QUERY CREATIONReference is now made to FIG. 6 where a query process 600 is depicted pursuant to some embodiments of the present invention. Query process 600 may be performed, for example, after a number of agents have been registered (e.g., using the process 500 of FIG. 5). Query process 600 may be performed under the direction of content protection system 200 to identify the presence and number of occurrences of unauthorized content associated with a particular item of content to be protected. For example, query process 600 may be used to direct a number of agents to perform queries of a number of networks to search the networks for occurrences of unauthorized copies of the motion picture SHREK.

Processing begins at 602 where a query request is received (e.g., from another process controlled by content protection system 200). The query request may include information identifying a particular item of content to be protected (e.g., the request may identify that the queries are to be submitted to identify all unauthorized copies of SHREK on all known file sharing networks). Processing continues at 604 where relevant query term(s) are defined based on the content to be protected. The queries may involve, for example, searching for the term “SHREK”. In some embodiments, queries are designed and performed to identify all available information associated with the unauthorized content (e.g., including information regarding the file format, size, and quality if available).

In some embodiments, content protection system 200 is manipulated to define one or more search terms which are believed to be likely to retrieve locations of unauthorized content associated with the content to be protected. In some embodiments, a selection may be made where specific file sharing networks may be particularly selected for searching (e.g., the content provider may indicate that it is only interested in unauthorized content on the largest file sharing networks).

A determination is made at 606 whether to scan networks in an automated or manual fashion. If automated, processing continues at 608 where a list of targeted networks and their characteristics (e.g. their connectivity protocols) are identified (e.g., by retrieving the information from network characteristic data 227 of content protection system 200). A query is constructed for each targeted network. If manual processing is selected, an operator may be prompted at 612 to enter information regarding targeted networks of interest.

Processing continues at 610 and 614 where an iterative process of creating queries for each targeted network is performed. Each query is constructed to conform to the network syntax and characteristics identified at 608 or 612. In some embodiments, different keywords and query structure may be generated for each network based on network syntax.

Processing continues at 616 where, for each query, the available agents are identified and are prepared and validated for launch of the querys. If insufficient agents are available (e.g., for a particular network), processing continues at 620 where a request for additional agent registration is submitted and new agents are registered using the process described above in conjunction with FIG. 5. In some embodiments, query process 600 requires identifying the appropriate number of query agents which are required to ensure adequate coverage of each targeted file sharing network so the results are meaningful and indicative of the average. In some embodiments, if the appropriate number and location of query agents is not known in advance, the number and characteristics of the query agents may be determined empirically to ensure appropriate coverage and sampling to appropriately identify all occurrences of unauthorized content on the targeted file sharing networks.

Processing continues at 622 where each of the queries are associated with agents and the agents are caused to perform the queries. Any query results are then returned to content protection system 200.

In some embodiments, query process 600 includes structuring queries in a manner to identify variants of the unauthorized content. For example, this may include structuring queries in a manner which allows the matching of the title title of the content to the file name or other descriptive attributes (e.g. meta-descriptors). For example, a movie″s title will be used to attempt to match existing files having the same or similar title.

After an agent performs a query, a response will be received from the file sharing network queried. The response to the queries along with information about the agent submitting the query and query results are stored at content protection system 200. Filtering may be optional or required depending on the degree of precision of the query and the items present on the network at the time of the query. This filtering can, for example, be performed by downloading files which correspond to the query criteria but are too small or too large as compared to a reference file created in the same format.

Upon completion of query process 600, information is stored at, or accessible to, content protection system 200 which identifies occurrences of unauthorized content related to the item of content to be protected. Further, system 200 has data identifying characteristics of unauthorized content. This information, as will be described, may be used to generate appropriate decoys and to disseminate those decoys.

DECOY CREATIONReference is now made to FIG. 7 where a decoy creation process 700 is depicted. Decoy creation process 700 may be performed under the control of content protection system 200. Processing begins at 702 where query(s) are performed for each item of content to be protected (e.g., the processing described above in conjunction with FIG. 6 is performed). The files satisfying the queries are retrieved, and the format of each retrieved file is identified. For example, the retrieved files are compared with known file formats to identify each retrieved file.

Further, because electronic files may be intentionally or accidentally mislabeled, additional attributes of the files may also be used as supplemental identification or filtering methods to eliminate false positives. For example, when available, supplemental descriptors may be used (for example, ID3v1 or ID3v2 tags for files in an MP3 format). This will help the identification of variations of a particular item of content.

Further, in some situations, false positives may emerge from a primary query. In some embodiments, a secondary screening criterion may be utilized. For example, one possible implementation of this secondary screening involves the creation of reference files. A set of reference files may be a set of electronic files created in different formats that are expected to be found on the targeted file sharing networks. Such files may be generated by using an original copy of the content to be protected and creating one or more copies of the content to be protected in various formats. This set of reference files may be established by identifying those formats which are popular or expected to be found on a targeted file sharing network for the type of content to be protected. This may be done at various resolutions. For example, for audio files, Windows Media Format (WMF), Sony® Advanced Audio Coding (AAC), MPEG layer 3 (MP3), Dolby″s Active Coding 3 (AC3) are currently popular formats. These formats and encoding methods will change over time and reference files may need to be re-generated modified accordingly.

In order to proceed with a secondary matching process, files which match the primary filter are downloaded and compared to the set of reference files (for partial or complete match). Once a file has passed the secondary screening, it will be deemed a match (samples or segments of a source file may have been extracted and also constitute unauthorized content).

Each of the retrieved files are analyzed to identify their format (this will possibly require the expansion of compressed file(s) prior to performing the format analysis). In some embodiments, a database or datastore containing all known file format characteristics is provided. In some embodiments, third party program calls may be required to identify certain file formats.

Processing at 714 includes the generation of a reference file based on each of the file formats identified. For example, continuing the SHREK example introduced above, reference files may be created in both .MPG and .WMF formats if those formats were formats which were used on the targeted file sharing networks.

Processing continues at 716 where a file alteration option is selected. A number of file alteration options may be provided. In some embodiments, the file alteration options depend on the type of content to be protected (e.g., some alterations are appropriate for video files but not for audio files). For example, alteration options may include: total absence of sound track for a motion picture; repeating, degraded images; sound track in a different language than the one used; modulation of the sampling rate; progressive degradation of sound quality, or image definition; introduction of a software bug which renders a game or other item of content unusable; etc. In some embodiments, because many P2P software clients allow users to preview content, file alteration options may include options leaving the first seconds/minutes of a file unaltered. This will encourage the user to complete the download only to find out later it is unusable. This practice is likely to yield desirable results since it is discouraging for a user to have invested the time and resources to attempt to illegally procure an item of content which turns out to have a defect that was not identifiable based on a simple preview.

Once a file alteration option is selected, processing continues at 718 where a decoy is created based on the selected reference file and the selected file alteration option. For example, if the selected reference file is a .MPG version of SHREK and if selected file alteration option is to remove the soundtrack, processing at 718 results in the creation of an MPG version of SHREK which lacks a soundtrack. In some embodiments, alteration is performed utilizing video-editing tools (for example Adobe® Premiere® 6.X video editing software) to strip a file from its soundtrack or substitute the soundtrack with another. In its simplest form, this method substitutes content with new content which is expected to disappoint the user.

In some embodiments, each decoy may be associated with one or more textual descriptors such as those used by file sharing networks to identify items of content. Users of file sharing networks may effectively create new decoys by copying a decoy and renaming it or otherwise associating new descriptors with it. In some embodiments, each decoy is created with a particular mark or identifier allowing content protection system 200 to identify a file as a decoy. For example, the text or meta-descriptor associated with each decoy may be generated to allow content protection system 200 to identify the file as a decoy (e.g., by using a particular coding or naming scheme). As another example, information may be embedded in the content of the decoy (e.g., in an early portion of the content) which associates the content with information in a meta-descriptor associated with the decoy, allowing content protection system 200 to identify that the content associated with the decoy has not been modified or replaced. As yet another example, a watermark, digital signature, hash, or other identifier may be incorporated in the decoy to allow content protection system 200 to uniquely identify the decoy as one having been created under its control or using its techniques.

The information used to uniquely identify a decoy is associated with the decoy at 720. This description tag may be used, for example, to mark each decoy for tracking and forensic purposes. For example, each decoy may be marked or tagged with a watermark or other appropriate marking means which allows content protection system 200 to readily distinguish between decoys and other content (e.g., such as unauthorized content). This allows the monitoring and analysis of the efficacy of the content protection process (e.g., by counting the occurrences of decoys as compared to the occurrences of unauthorized content). Other methods may include digital fingerprinting, public key cryptography, generation of a hash, or the like. In some embodiments, a digital signature is established for each decoy which allows each decoy to be particularly identified, even if the file name or descriptors are later changed or deleted by a subsequent user.

The process of generating a reference file, identifying a file alteration option, creating a decoy, and marking or tagging the decoy are repeated until a desired number of decoys is created and until decoys are created for each reference file. In general, decoys are created based on the most popular formats of unauthorized content which were identified by query process 600. The decoys are created to be similar to the unauthorized content in as many aspects as possible except for the introduction of one or more defects into the files. The defects are selected and introduced in a manner which will deliver an unexpected and disappointing result to the user who downloads the decoy. That is, each decoy is designed to exhibit all the characteristics the user expects except for the ability for the user to fully enjoy the content.

DISSEMINATIONOnce one or more decoys have been created (e.g., using the decoy creation process 700 of FIG. 7), processing continues to FIG. 8 where decoys are disseminated to targeted file sharing networks. Dissemination process 800 begins at 802 where a dissemination request for a particular item of content to be protected is received. Dissemination properties for the particular dissemination are identified at 804. For example, these dissemination properties may be identified based on manual instructions input into content protection system 200 (e.g., such as a specific request to disseminate a particular number of decoys to a particular network at a particular time). These dissemination properties may also be identified based on a model (e.g., such as a theoretical model 233 stored at system 200). The model may indicate that, for a particular item of content to be protected, the optimal dissemination will occur in a particular manner (e.g., by dissemination a certain number of decoys at a certain time). The dissemination process may utilize measurements made by content protection system 200 to optimize its distribution patterns. For example, content protection system 200 may measure type, number of occurrences and distribution of a given item of content to be protected to ensure that decoys are generated and disseminated in proportionate representations in various formats.

In some embodiments, dissemination properties identified at 804 may include details such as the placement of the decoys. For example, dissemination agents may be instructed to place the decoys in a shared physical or logical volume having a particular directory name and or structure which is selected to lure users into downloading the decoys. Other dissemination properties or instructions may also be provided to increase the efficacy of the dissemination.

Once the dissemination properties are identified, processing continues at 806 where available dissemination agents are identified. Embodiments of the present invention utilize agents (such as the agents described above in conjunction with FIG. 5) to disseminate decoys created in conjunction with the process of FIG. 7. A dissemination agent may be the same as a query agent created as described above, or it may be a newly created agent created for the specific purpose of disseminating decoys.

In some embodiments, it may be necessary or desirable to create a number of users in advance of a dissemination process to establish credentials with each targeted file sharing network. As networks become aware of the use of decoys, they may react by attempting to filter out or otherwise exclude dissemination agents of the present invention. Reputation may serve as one discrimination method used by file sharing networks. Accordingly, dissemination agents may be created prior to dissemination in order to establish accounts in good standing. Establishment of a good reputation may further involve the distribution of unauthorized content for a while. Once good reputations have been established, these dissemination agents may be utilized to disseminate decoys pursuant to embodiments of the present invention.

Once sufficient dissemination agents have been created, processing continues at 812 where decoys are associated with dissemination agents. The agents are then caused to disseminate the decoys at 814. For example, the agents may be provided with dissemination instructions identifying how, where, and when to make the decoys available. For example, some dissemination agents may be instructed to establish connections with specific networks, while other agents will be instructed to not establish connections to specific peers on the network (e.g., to not establish connections with other dissemination agents). Other dissemination instructions may specify details such as the bandwidth apparently available to other peers / users to download content (too little will dissuade users from using this source, too much will reduce efficacy as the file will be made available quickly to the user and increase the likelihood of the user identifying the true nature of the decoy), the time that the decoys are to be made available, or the like. Information may be stored associating each agent with the instructions provided to it.

Upon completion of dissemination process 800, a number of decoys are made available to users of targeted file sharing networks. If the decoys have been created appropriately, users will be tempted to download copies of the decoys over the file sharing networks. Preferably, the users will become discouraged upon attempting to view the decoy when the defective content is discovered. The efficacy of the dissemination is relative and will vary depending upon the expectations, for example, of the content provider. Embodiments of the present invention allow the efficacy of a particular dissemination to be monitored and analyzed. Further, embodiments of the present invention permit changes to be implemented to improve the efficacy of a dissemination.

MONITORINGReference is now made to FIG. 9 where a monitoring process 900 is depicted which may be performed, for example, by content protection system 200 in order to monitor the efficacy of a particular dissemination. Embodiments of the present invention allow the monitoring of disseminations to identify the efficacy of a particular dissemination. In part, this monitoring utilizes data from various queries and other processes to establish the effectiveness of a protection effort.

In some embodiments, the monitoring process 900 includes the capture and storage of network behavior or performance data (e.g., which may be stored as network performance data 237 at content protection system 200). This data may be captured and stored while dissemination is taking place and/or as a result of specific queries made to retrieve current data. These retrievals are generally referred to herein as “spot measurements” (which occur during dissemination) and “probe measurement” (which are the result of specific queries).

By monitoring network performance characteristics, information can be gathered and analyzed to identify the effects that a particular dissemination has on one or more file sharing networks. This information can then be used to adjust network characteristics (e.g., adjust the way agents disseminate decoys) and/or to adjust decoy characteristics (e.g., adjust the nature, format, quality, descriptive attributes, size, and/or structure of decoys).

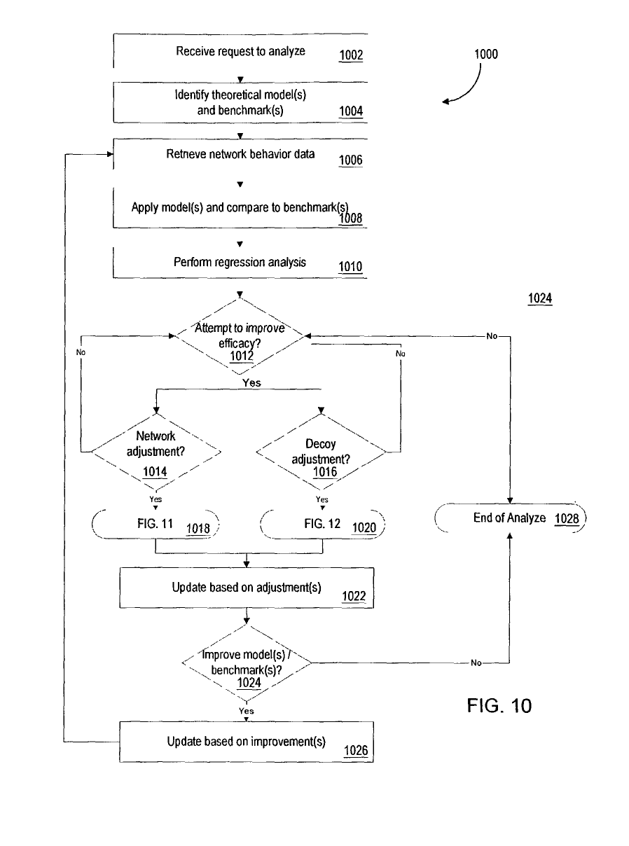

A number of different types of network data may be captured. For example, a spot measurement may include monitoring inbound and outbound data generated or received by content protection system 200. Information stored may include information identifying the nature of a particular message or request (e.g., identifying if the information is related to a query, file transfer request, cancellation of a file transfer, etc.), its origin (user identifier or name, IP address, etc.) as well as other relevant information (time of day, throughput of the connection, etc.). Once this information is captured, the data may be analyzed to determine if any further action is required. Analysis of the data is described further below in conjunction with FIG. 10.

Probe measurements may be used as a proactive means to identify network performance data at a particular time. Probe measurements may involve establishing or identifying one or more query agents and directing those query agents to submit a particular query to one or more file sharing networks. The results of the query are returned and stored at content protection system 200 for further analysis (e.g., using the method of FIG. 10). In some embodiments, both probe and spot measurements are used to capture different types of network data. The use of probe measurements may yield better results as they are likely to retrieve data in a manner similar to a typical user seeking content. It is believed that a majority of users submit queries seeking content rather than making content available for other users to download (e.g., up to 70% or more users of file sharing networks seek content and do not make content available). Probe measurements, in some embodiments, emulate this type of user by submitting queries seeking content. For example, probe measurements may involve submitting queries such as “title=SHREK”, retrieving a listing of all files on the network which contain content related to the motion picture SHREK. Results from these queries may need to filter out trailers or promotional materials which are legitimately distributed. This can be done, for example, by discriminating based on file size. As for the spot measurements, the results of probe measurements are stored in a data store located at (or accessible to) content protection system 200.

In some embodiments, spot and/or probe measurements are configured to identify the relative or absolute numbers of decoys on the file sharing networks. In some embodiments, decoys created by content protection system 200 may be identified by tags or other descriptors associated with the decoys. In this manner, content protection system 200 may identify the numbers and dissemination of these decoys. In some embodiments, spot and/or probe measurements may also be configured to identify the distribution of other types of decoys which may be placed on the file sharing networks (e.g., by other decoy generators).

Process 900 begins at 902 where a relevant model(s) is identified which is associated with a particular item of content to be protected. For example, a theoretical model may be established associated with motion picture files. The theoretical model may have a number of different relevant network variables for which data is required to apply the model. Processing at 904 involves retrieving or identifying relevant network behavior data (e.g., through either a spot or a probe measurement).

The relevant network behavior data may include the network variables required by the theoretical model selected at 902. For example, the following network characteristics may be retrieved: a number of agents online by network (handle); an age of agents (handle); a number of files shared by agents; a mix of files being shared (e.g., nature, format); an agent schedule of connection to the networks; the bandwidth made available to peers; the number of peer connections allowed; an age of IP address; a time & frequency of peer connection(s); a number of download attempts, success, aborts, cancellations, resumes; the “TTL” (time to live); an address of peers; the user identification of peers (handle); the name of directories & file name used; a frequency of decoy content changes; specific network characteristics (e.g., the “SuperNode” status of the Kazaa file sharing network); a variability of bandwidth over time; firewall usage; inter user messaging activity; or the like.

Processing at 906 includes comparing the retrieved network behavior data to one or more relevant benchmarks. For example, processing at 906 includes comparing actual data to targets or benchmarks. These benchmarks may be established manually (e.g., they may be specified by the content provider) or they may be calculated based on historical data or other information.

Processing at 908 includes determining whether the actual performance data of the networks is satisfactory. For example, if the network data indicates performance that is below a benchmark, processing continues to 910 where an exception is logged (e.g., alerting content protection system 200 to take corrective action to improve the efficacy of the dissemination). In some embodiments, processing at 908 includes comparing actual data to a benchmark and to a threshold (e.g., performance may be considered satisfactory if the actual data is within 10% or some other threshold of the benchmark target). If processing at 908 indicates that performance is satisfactory (e.g., the actual data is within a specified tolerance of a benchmark), processing continues to 912 where this information may be stored at (or accessible to) content protection system 200. This process may continue as desired. For example, repeated samples may be taken to continually or periodically measure network performance. In this manner, embodiments of the present invention allow the ready monitoring of the relative effectiveness of a dissemination. This process may be performed for each item of content to be protected and may be performed for each file sharing network.

By monitoring networks, content protection system 200 is able to identify any drop or change in the efficacy of a dissemination. It is anticipated that the dissemination of decoys will result in differing network effects and changes in user behaviors. Embodiments of the present invention allow these changes to be monitored in order to adapt the dissemination to those changes.

By collecting and amassing data regarding dissemination effects, the theoretical model(s) and benchmark(s) may be adapted to heuristically derive accurate models and benchmarks which account for statistical variances.

ANALYSISReference is now made to FIG. 10, where an analysis process 1000 is depicted which may be performed by, or under the control of, content protection system 200. In some embodiments, analysis process 1000 may be performed upon completion of monitoring process 900 based on the data collected in that process. In some embodiments, analysis process 1000 may be performed based on information collected by query or dissemination agents. Analysis process 1000 may be performed to assess the overall efficacy of a dissemination and may be used to implement and select a variety of changes to the dissemination process to improve its efficacy.

Processing begins at 1002 where a request to analyze is received (e.g., from another process of content protection system 200 or from an operator request for analysis). The request may identify a particular dissemination to analyze, or it may specify that all ongoing disseminations be analyzed.

Processing at 1004 includes identifying one or more models and benchmarks to utilize in the analysis (e.g., this may depend on the type of content being disseminated, the networks being used, etc.). Processing continues at 1006 where network behavior data is retrieved (e.g., this data may be stored at or accessible to content protection system 200 at data store 237). In some embodiments, processing at 1006 may further involve causing one or more network measurements to be performed (e.g., such as the monitoring of process 900) to retrieve current network performance data.

Processing continues at 1008 where the models are applied to the data and the resulting performance data is compared to the benchmarks to identify the relative efficacy of the dissemination process. A regression analysis may be performed on the data at 1010. Various statistical regression analyses may be performed between the characteristics of a specific decoy file which was disseminated (such as its format, descriptors, time of release) and its success in being propagated and adopted by users attempting to acquire an item of content.

In general, this analysis includes performing relevant analyses to measure the relative success of a particular dissemination. In some embodiments, success may be determined by measuring the evolution of the number of copies of decoys found over time as well as the number of locations where decoys are found. The exact metrics may vary over time. In some embodiments, analysis may involve targeting based on estimated “protection coefficients” equal to the rate at which decoys are found/retrieved as compared to illegitimate usable versions of content the system seeks to protect. This analysis will help determine if decoys cross over to different file sharing networks or distribution channels. In some embodiments, analysis may also include tracking the characteristics of decoys including: the lifespan of a decoy, the number of generations it was able to survive, the relative frequency of occurrence of decoys versus unauthorized content, and the number of new variances of copies of unauthorized content (reactivity of the networks). The analysis will also track changes in the structure, distribution, and descriptors on the networks which can be attributed to the introduction of the decoys.

Processing continues to 1012 where a determination is made whether to attempt to improve the efficacy of a particular dissemination. For example, an attempt to improve may be triggered based on a determination that a particular dissemination resulted in poor or unacceptable network performance data (e.g., the dissemination did not reduce unauthorized content). Further, network performance data may indicate that there have been changes in the file sharing networks which require some modification of the dissemination. The nature and number of file sharing networks may change over time. In some embodiments, content protection system 200 is able to adjust to these changes and to the appearance of new environments. In some embodiments, this adaptation is accomplished by accepting and integrating change requests to alter the distribution patterns (number of users, virtual vs. real user mix, time of day, number of times connected, and apparent bandwidth available, etc.).

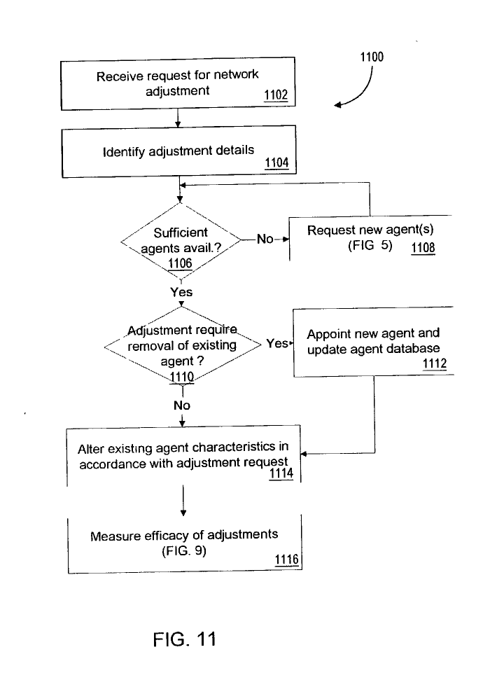

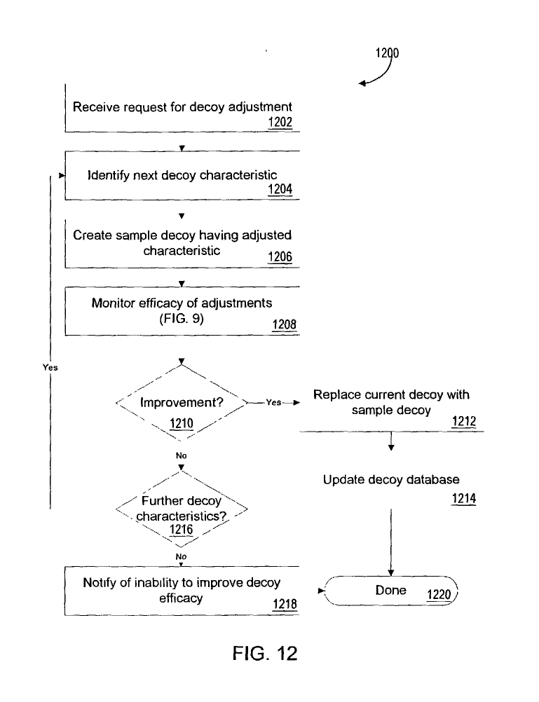

If a determination is made to attempt to improve the efficacy of a dissemination, processing continues to 1014 and/or 1016 where either a network adjustment or a decoy adjustment is performed (using the processes of FIGS. 11 and 12 respectively). These adjustments will be discussed further below.

Once appropriate adjustments have been made, data stored at content protection system 200 is updated to reflect the adjustments and processing reverts to 1006 where the process of analyzing is repeated. Further adjustments may then be made as needed to improve the efficacy of a dissemination. In this manner, individual changes can be introduced and their effects can be iteratively analyzed to arrive at an optimal dissemination. Further, this process can be used to establish and improve theoretical models and to establish accurate benchmarks.

For example, the process may be utilized to gather and review information to identify obvious correlated network variables. For example, if the bandwidth available to peers is an obvious factor influencing the number of files downloaded, a model may be established which encourages agents to be created having sufficiently large amounts of bandwidth. If no obvious relationship is identified between variables, a statistical regression analysis between variables may be performed. Once correlations are established, a theoretical model of the network and user behavior is hypothesized. This model can be informed manually as well and be altered by the results of the analysis of the information by the application itself. Multiple models are anticipated to be needed to address different networks and different types of user / peer behavior.

In some embodiments, the model is validated (or invalidated) by alterations of both dissemination and / or decoy characteristics. These changes trigger trial runs (short cycle monitoring) of the new characteristics. The reason for the trial run is to avoid degrading the efficacy of he application on a broad scale in the event that the new parameters are worse than the old ones. If they are better they are confirmed as better default values for decoy and dissemination agents and used by the applications as default values. In some embodiments, an attempt may be made to further simplify the model to ensure accuracy and establish direct influence of the variable.

ADJUSING NETWORK VARIABLESReference is now made to FIG. 11. In some embodiments, analysis process 1000 may indicate that some adjustment should be made to one or more network variables. Network adjustment process 1100 may be performed to introduce such adjustments. Network adjustment process 1100 begins at 1102 where a request for network adjustment is received (e.g., from the process 1000 of FIG. 10). The request may specifically identify one or more adjustments to be performed.

For example, if the analysis performed in process 1000 (FIG. 10) has determined that there is a strong correlation between the total number of users on a particular file sharing network and the number of dissemination agents required to maintain the protection efficacy, an adjustment request received at 1102 may include a request to provide additional dissemination agents as a result of a detected increase in the number of total users on the network.

Based on the requested adjustments, processing continues to 1106 where a determination is made whether sufficient agents are available. If not, further agents are registered (e.g., using the process of FIG. 5). In some embodiments, new agents are registered using new agent characteristics (e.g., new agents may register with new names or with new bandwidth characteristics, etc.). In some embodiments, the removal of certain agents may be necessary (e.g., analysis may indicate that certain registered agents are not achieving satisfactory results).

Certain changes may require abandoning (or resetting) an existing agent to modify its properties. Some characteristics will require a complete re-creation of the agent (such as an IP address) others can be modified dynamically (e.g., bandwidth allowable per peer). Some changes may result in altering characteristics of certain agents or replacing agents with new agents. Based on the changes, the agent database of content protection system 200 is updated. In some embodiments, processing may revert to the monitoring process (FIG. 9) to assess the effect of the alteration. Meaningful efficacy variables are compared to the established benchmark (accounting for statistical variances through established tolerances). This spot measurement allows the application to determine if efficacy has improved or regressed.

In this manner, embodiments of the present invention may efficiently respond to network changes and correct or improve poor network performance, thereby increasing the efficacy of disseminations.

ADJUSTING DECOY CHARACTERISTICSReference is now made to FIG. 12. In some embodiments, analysis process 1000 may indicate that some adjustment should be made to one or more decoy characteristics. Decoy adjustment process 1200 may be performed to introduce such adjustments.

Process 1200 begins at 1202 where a request for decoy adjustment is received (e.g., from analysis process 1000 of FIG. 10). This request may specify one or more adjustment details. For example, analysis at 1000 may indicate that users of a particular file sharing network have modified their behavior and are now seeking content labeled differently than it was when the decoys were initially disseminated. The request received at 1202 may include a request to change the file names or labels of the decoys and to disseminate a certain number of the new decoys. As another example, analysis at 1000 may indicate that users are now seeking content formatted using a different format. The request at 1202 may be request to produce new decoys in the newly popular format.

In some embodiments, multiple changes may be specified. In some embodiments, each change is performed in sequence to create a sample decoy having the modification. The sample decoy may be disseminated and the networks may be monitored to determine the efficacy of the modification. If the modification results in an improvement, the new, altered decoy is used as the disseminated decoy. This process may be repeated until each modification has been implemented and tested for efficacy to identify the optimal decoy configuration. Information identifying the altered decoys may be stored at, or accessible to, content protection system 200.

Although the present invention has been described with respect to a preferred embodiment thereof, those skilled in the art will note that various substitutions may be made to those embodiments described herein without departing from the spirit and scope of the present invention.

1. A method for protecting an item of content, comprising:
monitoring a plurality of file sharing networks to identify at least a first file sharing network having said item of content;
creating at least first and second reference files associated with said item of content, said first and second reference files each having a different format;
creating a plurality of decoy files, including a first set of decoy files created from said first reference file, and a second set of decoy files created from said second reference file, each of said decoy files including a defect; and
disseminating said decoy files to said first file sharing network.

2. The method of claim 1 , further comprising causing a plurality of dissemination agents to register with said at least first file sharing network, and wherein said disseminating further includes causing said dissemination agents to disseminate said decoy files to said first file sharing network.

3. The method of claim 1 , further comprising:
causing a plurality of query agents to register with said at least first file sharing network, and wherein said monitoring further includes causing said query agents to submit queries to said at least first file sharing network.

4. The method of claim 1 , further comprising:
identifying a network syntax associated with said at least first file sharing network;
identifying a connectivity requirement associated with said at least first file sharing network; and
causing a plurality of agents to register with said at least first file sharing network using said network syntax and said connectivity requirement.

5. The method of claim 1, further comprising:
analyzing said first file sharing network to identify an effect of said disseminating.

6. The method of claim 5, wherein said analyzing further comprises:
comparing information about said first file sharing network to an expected behavior model;
disseminating additional decoy files to said first file sharing network if said comparing indicates that said first file sharing network requires additional decoy files.

7. The method of claim 6 , further comprising:
adjusting said expected behavior of dissemination model.

8. The method of claim 5 , wherein said analyzing further comprises:
comparing information about said first file sharing network to an expected behavior model;
generating a third set of decoy files having different characteristics selected based on said comparing; and
disseminating decoy files from said third set to said first file sharing network.

9. The method of claim 1 , further comprising:
causing a plurality of agents to register as users of said first file sharing network.

10. The method of claim 1, wherein said creating said reference files further comprises:
identifying a format associated with said first file sharing network; and
wherein at least one of said first and second reference files are created in said format associated with said first file sharing network.

11. The method of claim 1, wherein said creating said reference files further comprises:
identifying a plurality of alternative file formats associated with a media type of said item of content, wherein said first and second reference files are created based on said identified file formats.

12. The method of claim 1 , wherein said creating said reference files further comprises:
identifying a plurality of alternative file formats associated with a media type of said item of content; and
creating a plurality of reference files from said item of content, each reference file having a different one of said plurality of alternative file formats.

13. The method of claim 1 , wherein said creating said reference files further comprises creating said reference files from a digital master copy of said item content.

14. The method of claim 1 , wherein said monitoring further comprises:
identifying the number of said files on said first file sharing network.

15. The method of claim 14 , wherein said identifying further comprises:
detecting at least one of an expected file name, a file size, a file format, a variant of said expected file name, a meta-descriptor, and a supplemental descriptor.

16. The method of claim 15 , wherein said identifying further comprises:
performing a secondary identification process if said file can not be identified based on said detecting.

17. The method of claim 14 , wherein the number of decoy files in said first and second sets is based on the number of said items of content on said first file sharing network.

18. The method of claim 14 , wherein the number of decoy files in said first and second sets is selected to be sufficient to degrade performance of said first file sharing network.

19. The method of claim 1 , wherein said monitoring further comprises:
querying each of said plurality of file sharing networks to identify a number of files matching any of said first and second reference files.

20. The method of claim 19 , wherein each query is performed by an agent registered to participate in at least one of said plurality of file sharing networks.

21. The method of claim 1, wherein said creating a first set of decoy files further comprises
marking each of said decoy files with an identifier distinguishing said decoy files from said item of content.

22. The method of claim 21, wherein said identifier uniquely identifies said decoy to an entity creating said decoy, wherein said identifier is selected from the group consisting of: a digital watermark; a digital fingerprint; a hash; and a digital signature.

23. The method of claim 1 , wherein said file is at least one of an audio file, a video file, an image, a software file, a text file and a data file, and said defect is selected from the group consisting of: a modification of one or more portions of the file; a repeating of portions of the file; a degradation of one or more portions of the file; a progressive degradation of portions of the file; and a modulation of a sampling rate of the file.

24. The method of claim 1 , wherein said first set of decoy files includes at least a first and a second subset, wherein the decoy files in said first subset have a different defect that the decoy file in said second subset.

25. The method of claim 1, wherein said disseminating further comprises:
providing said first and second pluralities of decoy files to at least a first agent registered to participate in said first file sharing network; and
causing said agent to make said decoy files available to other users of said first file sharing network.

26. The method of claim 1 , further comprising:
providing said first and second pluralities of decoy files to at least a first agent registered to participate in said first file sharing network;
providing said agent with dissemination instructions; and
causing said agent to make said decoy files available to other users of said first file sharing network pursuant to said dissemination instructions.

27. The method of claim 26 , wherein said dissemination instructions include at least one of: a time of dissemination; a number of decoys to disseminate; and at least a first network variable.

28. The method of claim 1 , wherein said creating said plurality of decoy files further comprises associating each of said decoy files with a validating characteristic.

29. The method of claim 28, wherein said validating characteristic is a hash function.

30. A method for protecting an item of content, comprising:
causing at least a first agent to register as a user of a file sharing network;
receiving data from said first agent identifying an unauthorized copy of said item of content, said unauthorized copy having a format;
creating a reference file based on said item of content in said format; identifying a plurality of defects;
creating a plurality of decoy files from said reference file, each of said decoy files having one of said plurality of defects; and
causing said first agent to disseminate said plurality of decoy files using said file sharing network.
